(19) United States
(12) Patent Application Publication
(10) Pub. No.: US 2016/0071387 A1
(43) Pub. Date: Mar. 10, 2016

(54) FIRE SAFETY SYSTEM

(71) Applicant: Michael Leonard Fabre, Baton Rouge, LA (US)

(72) Inventor: Michael Leonard Fabre, Baton Rouge, LA (US)

(21) Appl. No.: 14/848,862

(22) Filed: Sep. 9, 2015

Related U.S. Application Data
(60) Provisional application No. 62/047,834, filed on Sep. 9, 2014.

(51) Int. Cl. G08B 17/10

(52) U.S. Cl. CPC G08B 17/10

(57) ABSTRACT

A fire safety system is provided. The fire safety system is adapted for waking a sleeping person from a bed when detecting a predetermined level of smoke in a space occupied by the bed, actuating a nearby egress, and then leading them to and through said nearby egress. The fire safety system may provide an alarm system including visual, audio and vibratory delivery mechanisms for awaking the sleeping person. The fire safety system may provide a lighting assembly to guide the wake person to the egress. The fire safety system may provide an actuating assembly operably coupled to at least on locking assembly mounted to the egress so that the actuating assembly may move an egress covering from a locked position to an unlocked position and then from a closed to an opened position.

### CROSS-REFERENCE TO RELATED APPLICATION

This application claims the benefit of priority of U.S. provisional application No. 62/047,834, filed 9 Sep. 2014, the contents of which are herein incorporated by reference.

### BACKGROUND OF THE INVENTION

The present invention relates to fire safety systems and, more particularly, to a fire safety system that detects smoke, wakes a sleeping person and opens a nearby egress. According to The National Fire Prevention Association, 1,375 single family homes burn each year. Killing 2,855 people on average.

Children under the age of five are twice as likely to die in a house fire due to smoke inhalation while sleeping as the general population. Most deadly fires occur late at night and by the time children wake up, the smoke has already become a thick cloud which limits visibility. Currently, fire safety protocol teaches children to feel doors for heat to determine safe passage. This training allows children to determine if they can escape out the front door or if they should open a window to get out. A contributing factor to this death rate is that young children cannot open their windows on their own, effectively cutting off an escape route.

Meanwhile, smoke detectors use only an audible alarm, which if not sufficient to wake a sleeping person could result in a tragedy. When the sleeping person is hearing impaired, the risk is appreciably higher.

As can be seen, there is a need for a fire safety system can be installed during construction or retrofitted that detects smoke, wakes a sleeping person and opens a bedroom window already required by local building codes.

### SUMMARY OF THE INVENTION

In one aspect of the present invention, a fire safety system includes an egress, a lock assembly and an actuating assembly, both mounted to an egress cover, such as a window, of the egress. The lock assembly is mounted to a movable frame of the egress cover, wherein the lock assembly is positionable in an unlocked position and a locked position locking the movable frame of the egress cover. The actuating assembly is mounted onto a stationary frame of the egress cover so as to be movable from a closed position to an open position, positioning the lock assembly and lifting the movable frame of the egress cover from the egress; and a smoke detector operably connected to the actuating assembly when the smoke detector detects a predetermined threshold of hazardous substance.

In another aspect of the present invention, a fire safety system includes an egress having a movable egress covering; a sleeping apparatus adapted to sleep a human occupant; an actuating assembly mounted along a periphery of the egress for moving the egress covering from a closed position to an open position; a smoke detector operably connected to the actuating assembly when the smoke detector detects a predetermined threshold of hazardous substance; an output module adapted to produce audio sounds, wherein the audio sounds comprise a human voice familiar to the human occupant; an input module adapted to record the human voice; a vibrating mechanism adapted to shake the sleeping apparatus; a lighting assembly disposed between the egress and the sleeping apparatus; a control system electrically connected between the smoke detector and the actuating assembly, the output module, the input module, the vibrating mechanism, and the lighting assembly so that when the smoke detector detects the predetermined threshold of hazardous substance the control system is operable; and a step assembly disposed near the egress.

In yet another aspect of the present invention, the fire safety system includes opposing side cables connected to the egress covering, wherein at least one side cable wraps around at least three pulley wheels at least one locking assembly mounted to the egress covering, wherein the at least one locking assembly interconnects at least one of the side cables and the egress covering, and wherein each locking assembly is movable from a locked engagement to an unlocked position as the egress covering moves to the open position.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a detailed perspective view of an exemplary embodiment of the present invention;

FIG. 3 is a detailed perspective view of an exemplary embodiment of a control system of the present invention;

FIG. 4 is a lower perspective view of an exemplary embodiment of an actuator assembly of the present invention, illustrating the mechanical relationship with an egress covering by hiding/dashing some components to illustrate others;

FIG. 5 is a front detail view of an exemplary embodiment of side cables of the actuator assembly of the present invention, hiding/dashing some components to further illustrate others;

FIG. 6 is a front detail view of an exemplary embodiment of the actuating assembly of the present invention, hiding/dashing some components to distinguish a right side cable pathway;

FIG. 7 is a lower prospective view of an exemplary embodiment of the actuating assembly of the present invention, illustrated in an expanded state, when a connected egress covering is in a closed position;

FIG. 8 is a lower perspective view of an exemplary embodiment of the actuating assembly of the present invention, illustrating movement to a contracted state, whereby the connected egress covering moves to an open position;

FIG. 9 is a detail perspective view of an exemplary embodiment of a lock assembly of the present invention, shown in use;

FIG. 10 is a detail front perspective view of an exemplary embodiment of the lock assembly of the present invention;

FIG. 11 is a detail rear perspective view of an exemplary embodiment of the lock assembly of the present invention;

FIG. 12 is a section detail view of an exemplary embodiment of the present invention along line 12-12 in FIG. 9 (illustrated in a locked position); and

FIG. 13 is a section detail view of an exemplary embodiment of the present invention (illustrated in an unlocked position).

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fire safety system for waking a sleeping occupant from a bed when operable after detecting a predetermined level of smoke in a space occupied by the bed. When operable, the fire safety system actuates a nearby egress, and then leads the awakened occupant to and through said nearby egress. The fire safety system may provide an alarm system including visual, audio and vibratory delivery mechanisms for awaking the sleeping person. The fire safety system may provide a lighting assembly to guide the wake person to the egress. The fire safety system may provide an actuating assembly operably coupled to a egress covering for moving it from a closed position to an opened position.

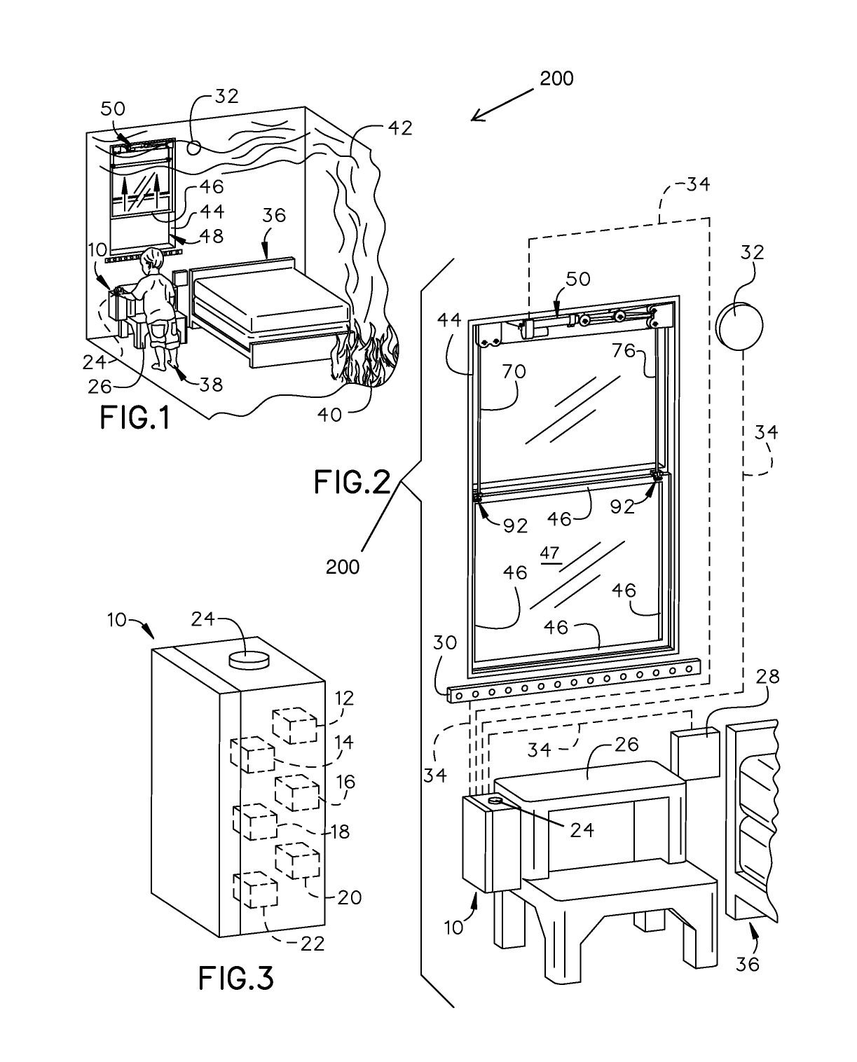

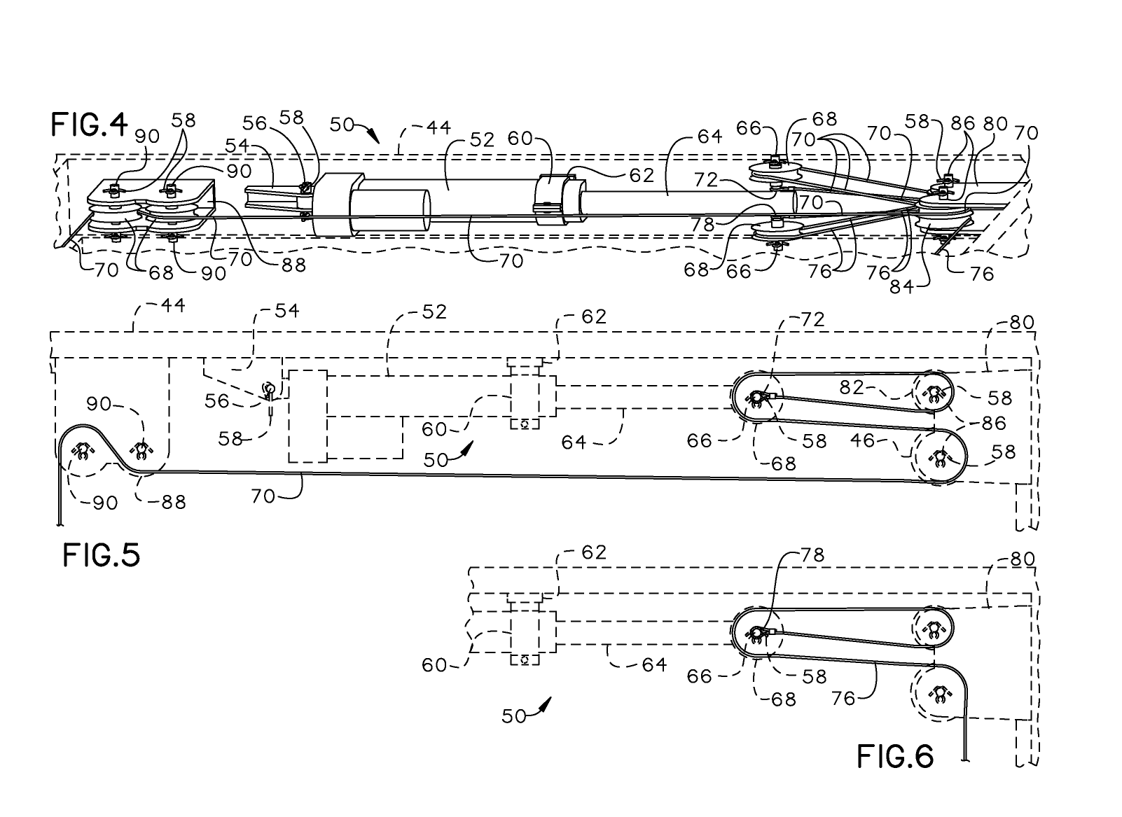

Referring now to FIGS. 1 through 13, the present invention provides a fire safety system 200 for waking a sleeping occupant 38 from a bed 36, guiding them to at least one nearby egress 48, while automatically and/or remotely moving the egress covering 47 thereof from a closed to an open position. The fire safety system 200 may include a smoke detector 32, an actuating assembly 50, a vibrating mechanism 28, a lighting assembly 30 electrically connected via exemplary electrical connections 34 (or wirelessly) to a control system 10 and a power source 16. The power source 16 may include at least one rechargeable battery electrically connected to a battery charger. The power source 16 may provide an indicator light when a predetermined threshold of electric power is detected.

The smoke detector 32 may be adapted to detect a predetermined threshold of hazardous substance 42 in a space occupied by the sleeping occupant 38, wherein a smoke signal is electronically transmitted to the control system 10. The smoke signal may be transmitted when the predetermined threshold of hazardous substance 42 is smoke from a fire 40. In certain embodiments, the hazardous substance 42 may be other deadly vapors, gases, particulates or the like.

The control system 10 may be adapted to transmit an alarm signal upon receiving said smoke signal. The control system 10 may house an input module 12, an output module 14, a trickle charger 18, standard relays 20 and flasher relays 22. The control system 10 may provide a push-button 24 for controlling operability.

The lighting assembly 30 may include a plurality of light sources, such as light-emitting diodes (LEDs), fiber optic lights or the like. The lighting assembly 30 may be disposed between a sleeping apparatus 36 (e.g., a bed of the room occupant 38) and each egress 48. In addition, the lighting assembly 30 may be disposed near other components of the fire safety system 200, such as the control system 10 or a stepping apparatus 26, making them more visible in the presence of the predetermined threshold of hazardous substance 42. The lighting assembly 30 may be adapted to intermittently activate the plurality of light sources when receiving the alarm signal from the control system 10.

The output module 14 and input module 12 may include at least one speaker and at least one microphone, respectively. The input-output modules 12, 14 may be designed for recording and playing back a plurality of audible sounds such a verbal warning messages. Said verbal warning messages may be recorded from individuals that the occupant 38 recognizes, for example, someone they look up to as an authority figure, such as a parent or guardian. The input module 12 may be adapted for receiving audible signals. The output module 14 may be adapted for audibly projecting the plurality of audible sounds, such as the warning message. The input-output module 12 preferably has a recording button for activating the input module 12 to record the plurality of audible sounds. The output module 14 may include a chirper adapted to produce alarming noises at a decibel level that may be perceived as pain by the nearby sleeping occupant 38. The output module 14 may be adapted to intermittently projected the plurality of audible sounds and/or the alarming noises from the at least one speaker. The output module 14 may be adapted to become operable upon receiving the alarm signal from the control system 10.

The vibrating mechanism 28 may be adapted to shake the sleeping apparatus 36 so as to awake a sleeping occupant 38. The vibrating mechanism 28 may be adapted to be operable upon receiving the alarm signal from the control system 10.

The step apparatus 26 may be disposed near each egress 49 for accessing the egress 48. In certain embodiments, the step apparatus 26 may be coupled to the control system 10. The at least one egress 48 may be a window, door, or other opening with a movable egress covering 47. When the egress 48 is be a window, for example, the egress covering 47 is the movable window pane.

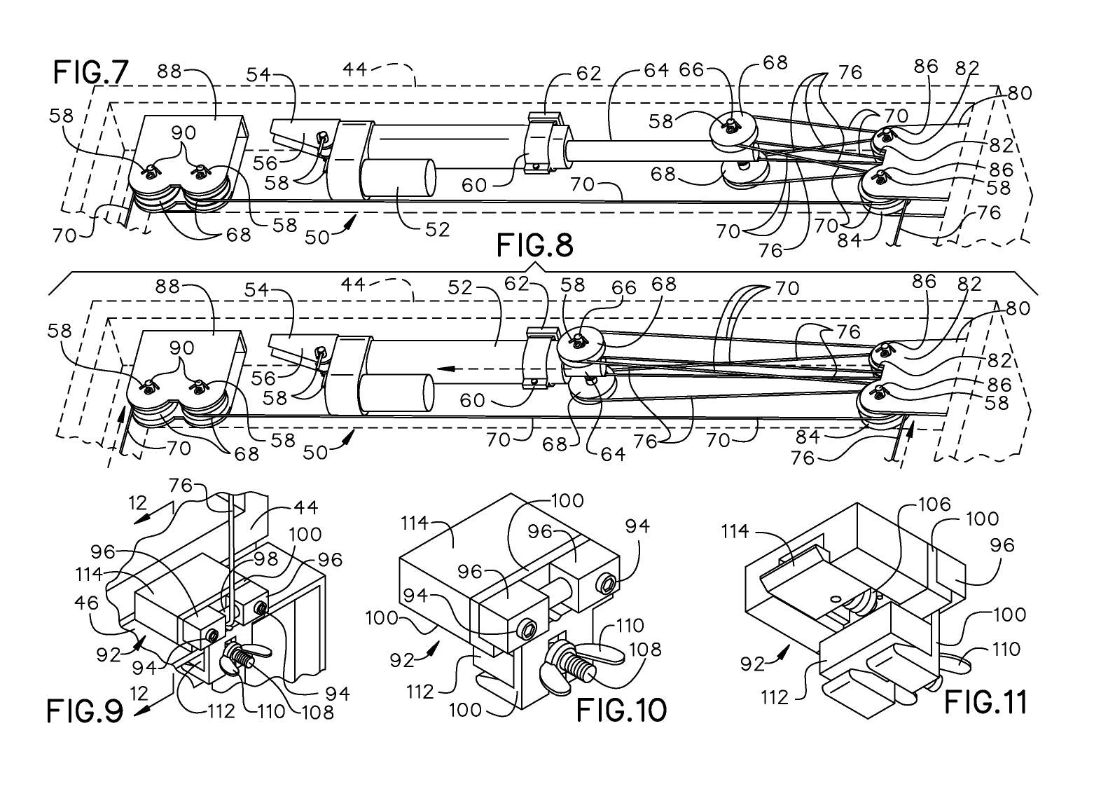

The actuating assembly 50 may be disposed along each egress 48. Each egress 48/egress covering 47 may include peripheral framing 44 coupled with auxiliary framing 46 movable along the peripheral framing 44 for moving at least a portion of the egress covering 47 from the closed position to the open position, whereby making the egress 48 accessible for the occupant 38. The actuating assembly 50 may be mounted to the peripheral framing 44 (or coupled along the peripheral framing 44) and extend to the auxiliary framing 46 via cables 70, 76 so that when the actuating assembly 50 move from an expanded state to a contracted state, as illustrated in FIGS. 7 and 8, the egress covering 47 moves to the open position.

The auxiliary framing 46 may be removably held in a locking engagement by a lock assembly 92, wherein the lock assembly 92 is movable from a unlocked position to a locked position, forming the locking engagement. The lock assembly 92 may be mounted along the auxiliary framing 46. In certain embodiments, each cable 70, 76 may interface with the lock assembly 92 so that when the actuating assembly 50 contracts, moving the auxiliary framing 46 to the open position, the lock assembly 92 are repositioned to the unlocked position.

The actuating assembly 50 may be electrically connected to the control system 10 to be operable when receiving the alarm signal from the control system 10. The actuating assembly 50 may include, but not be limited to, brackets, clevis pins, cables guide wheel, a linear actuator body 52, a linear actuator mount bracket 54, a linear actuator mount bracket pivot rod 56, a cotter pin 58, an actuator support clip 60, an actuator support clip spacer block 62, an actuator expanding/contracting shaft 64, an actuator expanding/contracting shaft pivot rod 66, a single cable pulley wheel 68, a left side cable 70, a left side cable loop for actuator extending/retracting shaft pivot rod 72, a cable loop 74 for interfacing/engaging the lock assembly 92, a right side cable 76, a right side cable loop for actuator extending/retracting shaft pivot rod 78, an asymmetric bracket 80, a double cable pulley wheel (small) 82, a double cable pulley wheel (large) 84, an asymmetric bracket pivot rods 86, a symmetric bracket 88 and a symmetric bracket pivot rod 90 In certain embodiments, the actuating assembly 50 may be operably coupled to the egress 48 to catch and lift any dressing selectively covering the egress 48, providing a clear path through the egress 48. The actuating assembly 50 may provide a break button to render it inoperable for resetting it and/or position the lock assembly 92 in the locked position.

The actuating assembly 50 may be mounted along the periphery of the egress 48 so that the left and right side cables 70, 76 extend and connect to opposing sides of a portion of the movable auxiliary framing 46, as illustrated in FIG. 2. At least one side cable 70, 76 may wrap around a set of at least three pulley wheels 68, 82, 84 so that every inch that the actuator extending/retracting shaft 64 moves, the side cables 70, 76 move three inches, providing a displacement advantage when moving the egress covering 47 from the closed position to the open position.

The actuating assembly 50 may be adapted to provide sufficient pounds of force to move the egress covering 47. The actuating assembly 50 may be mounted along the periphery of the egress 48 so as to take up limited space, as illustrated in the FIGS., and so as to allow aesthetically covering it with dressing.

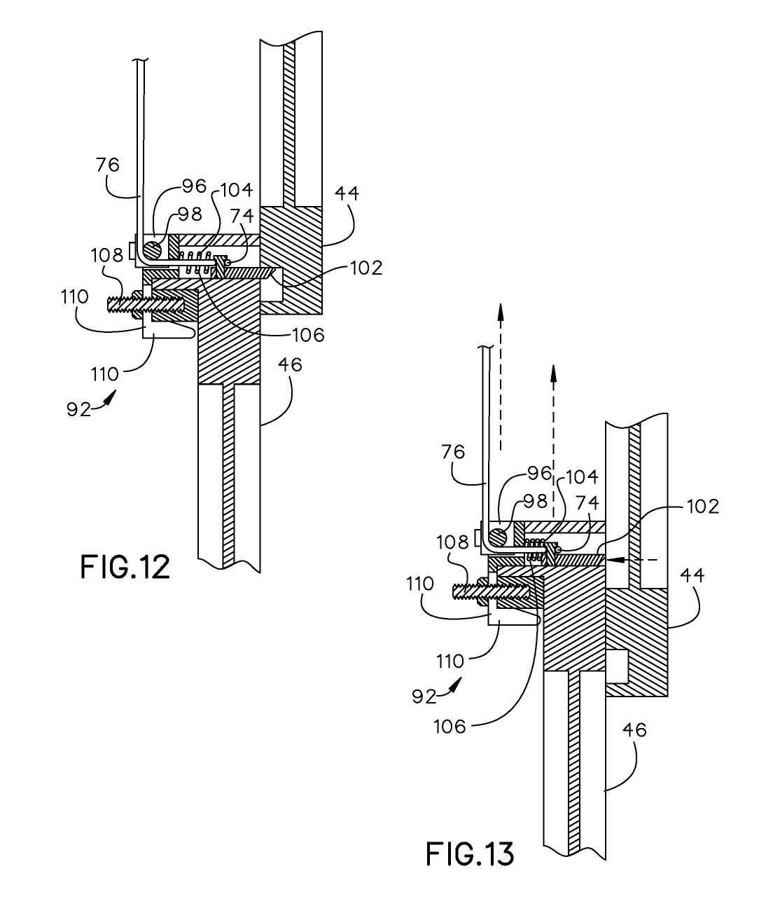

Each side cable 70, 76 may be operably coupled to the lock assembly 92 so as to position the lock assembly 92 to the unlocked position (from the locked position) when the actuating assembly 50 moves to the contracted state, moving the auxiliary framing 46/egress covering 47 to the open position. To wit, the lock assembly 92 may include a pin block fastener 94, a pin block 96, a cable pin 98, a locking hook bracket 100, a latch 102, a latch fastener 104, a spring 106, a threaded post 108, a wing-nut 100, a spacer block 112 and a latch housing 114, whereby the cable loop 74 of a cable 70 or 76 of a contracting actuating assembly 50 repositions the spring-biased latch 102 so that the lock assembly 92 is positioned in the unlocked position, as illustrated in FIGS. 12 and 13.

A method of using the present invention may include the following. The fire safety system 200 disclosed above may be provided. Upon receiving the alarm signal, the actuating assembly 50, the vibrating mechanism 28, the lighting assembly 30 and the output module 14 may be activated. The vibrating mechanism thus shakes the sleeping apparatus 36 while the output module 14 produces verbal commands of the occupant's authority figure, wherein these verbal commands use the occupant's name and provide directions to the occupant 38. The lighting assembly 30 produces light, facilitating the occupant 38 in finding the egress 48, the step apparatus 26, and the control system 10.

In certain embodiments, the actuating assembly 50 may be activated only upon depression of the push-button 24, for example by the occupant 38. In certain embodiments, an alarm sound may be produced by output module 14 when the push-button 24 is depressed so as to alert others, such as the occupant's parents, that the actuating assembly 50 is activated.

It should be understood, of course, that the foregoing relates to exemplary embodiments of the invention and that modifications may be made without departing from the spirit and scope of the present invention.

What is claimed is:

1. A fire safety system, comprising:
an egress having a movable egress covering;
an actuating assembly mounted along a periphery of the egress for moving the egress covering from a closed position to an open position; and
a smoke detector operably connected to the actuating assembly when the smoke detector detects a predetermined threshold of hazardous substance.

2. The fire safety system of claim 1, further comprising a control system electrically connected between the smoke detector and the actuating assembly so that when the smoke detector detects the predetermined threshold of hazardous substance the control system is operable.

3. The fire safety system of claim 2, wherein the control system houses an output module, wherein the output module is adapted to produce audio sounds.

4. The fire safety system of claim 3, wherein the audio sounds comprise a human voice.

5. The fire safety system of claim 4, wherein the control system houses an input module, wherein the input module is adapted to record the human voice.

6. The fire safety system of claim 5, further comprising a sleeping apparatus adapted to sleep a human occupant, wherein the human voice is familiar to the human occupant.

7. The fire safety system of claim 6, further comprising a vibrating mechanism adapted to shake the sleeping apparatus, wherein the vibrating mechanism is electrically connected to the control system.

8. The fire safety system of claim 7, further comprising a lighting assembly disposed between the egress and the sleeping apparatus, wherein the lighting assembly is electrically connected to the control system.

9. The fire safety system of claim 1, further comprising a step assembly disposed near the egress.

10. The fire safety system of claim 1, wherein the actuating assembly comprises opposing side cables connected to the egress covering, wherein at least one side cable wraps around at least three pulley wheels.

11. The fire safety system of claim 10, further comprising at least one locking assembly mounted to the egress covering, wherein the at least one locking assembly interconnects at least one of the side cables and the egress covering, and wherein each locking assembly is movable from a locked engagement to an unlocked position as the egress covering moves to the open position.

12. A fire safety system, comprising:
an egress having a movable egress covering;
a sleeping apparatus adapted to sleep a human occupant;
an actuating assembly mounted along a periphery of the egress for moving the egress covering from a closed position to an open position;
a smoke detector operably connected to the actuating assembly when the smoke detector detects a predetermined threshold of hazardous substance;
an output module adapted to produce audio sounds, wherein the audio sounds comprise a human voice familiar to the human occupant;
an input module adapted to record the human voice;
a vibrating mechanism adapted to shake the sleeping apparatus;
a lighting assembly disposed between the egress and the sleeping apparatus;
a control system electrically connected between the smoke detector and the actuating assembly, the output module, the input module, the vibrating mechanism, and the lighting assembly so that when the smoke detector detects the predetermined threshold of hazardous substance the control system is operable; and
a step assembly disposed near the egress.

13. The fire safety system of claim 12, wherein the actuating assembly comprises opposing side cables connected to the egress covering, wherein at least one side cable wraps around at least three pulley wheels.

14. The fire safety system of claim 13, further comprising at least one locking assembly mounted to the egress covering, wherein the at least one locking assembly interconnects at least one of the side cables and the egress covering, and wherein each locking assembly is movable from a locked engagement to an unlocked position as the egress covering moves to the open position.
